(19) United States
(12) Patent Application Publication
(10) Pub. No.: US 2021/0162432 A1
(43) Pub. Date: Jun. 3, 2021

(54) SPRAY DEVICE

(71) Applicant: WUHAN CHINA STAR OPTOELECTRONICS SEMICONDUCTOR DISPLAY TECHNOLOGY CO., LTD., Wuhan (CN)

(72) Inventor: Jianfeng CHEN, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 16/630,440

(22) PCT Filed: Oct. 9, 2019
(86) PCT No.: PCT/CN2019/110067

§ 371 Date: Jan. 12, 2020

(51) Int. Cl. B05B 3/14; B08B 3/02; G02F 1/13

(52) U.S. Cl. CPC B05B 3/14; G02F 1/133792; G02F 1/1316; B08B 3/024

(57) ABSTRACT

A spray device is provided. The spray device is capable of using in a production process of a liquid crystal display and disposed in a spray chamber. The spray device includes an upper rack, a connector, an eccentric wheel, and a motor. The eccentric wheel includes a center hole, a plurality of eccentric holes, and a connecting rod. The center hole is fixedly connected to the eccentric wheel. The eccentric holes are disposed on the eccentric wheel. The connecting rod is fixedly mounted on one of the eccentric holes. A rocker is sleeved on the connecting rod to realize a rotatable connection. The motor is configured to drive the eccentric wheel to rotate. The connecting rod is configured to rotate with the eccentric wheel to drive the rocker to realize a reciprocating motion of the upper rack.

### FIELD OF DISCLOSURE

The present disclosure relates to the field of microelectronic processing equipment technologies, and in particular, to a spray device used in a production process of a liquid crystal display.

### BACKGROUND

In the field of display technologies, liquid crystal displays (LCDs) and organic light-emitting diode (OLED) display devices have gradually replaced cathode ray tube (CRT) displays.

The LCD is formed by laminating a thin film transistor array substrate (TFT array substrate) and a color filter (CF) substrate, and liquid crystal molecules are injected between the TFT substrate and the CF substrate, and the liquid crystal molecules are controlled to change direction by whether those are energized or not, and light emitted by a backlight module is refracted to generated an image.

In a TFT-LCD manufacturing process, indium tin oxide (ITO) has been widely used to form a transparent display electrode, due to its excellent property. During a process for fabricating an ITO transparent display electrode, an ITO film is firstly formed by a magnetron sputtering process, and then a pattern of photoresist is formed by photolithography. Finally, the ITO film is patterned by a wet etching process to form the transparent display electrode.

FIG. 1 is a flowchart of spraying and etching an ITO film in the prior art. Referring to FIG. 1, a surface of a substrate is covered with an ITO film, and the substrate enters an input unit (IN CV). Organic matter on the surface is removed in a cleaning chamber (EUV), and then substrate enters an etching chamber (ETCH). In the etching chamber, a portion the ITO film which is not required to remain (i.e., a portion of the ITO film which is not covered by a photoresist pattern) on the substrate is removed by an etchant. The substrate then leaves and is cleaned by a water washing unit (SWR) to remove the etchant remaining on the surface of the substrate. Finally, the substrate is dried and transferred out of a spray device by a transfer unit (NT) and an outlet unit (OUT CV).

However, in the cleaning chamber (EUV), the etching chamber (ETCH), and the water washing unit (SWR), the substrate is sprayed by using fixedly mounted spray devices. The cleaning chamber (EUV) and the water washing unit (SWR) wash the substrate to remove impurities, and crystals of the etching liquid are generated in the etching chamber (ETCH). Therefore, nozzles on the spray devices may be clogged during the production process, or an offset of the spray may occur for other reasons, so that the substrate is unevenly sprayed, and eventually the product is defective.

### SUMMARY OF DISCLOSURE

In view of the above technical problems, the present disclosure provides a spray device. By driving a spray rack for spraying with a reciprocating motion, a substrate is evenly sprayed, and an offset of the spray is reduced. The substrate is sprayed evenly, and a production efficiency and product quality are improved.

In order to solve the above problems, the present disclosure provides a spray device capable of using in a production process of a liquid crystal display and disposed in a spray chamber. The spray device includes an upper rack, a connector, an eccentric wheel, and a motor. Specifically, the upper rack is movably mounted on a top of the spray chamber, and a plurality of nozzles are evenly arranged below the upper rack. The connector is disposed on one side of the upper rack, and is rotatably connected to the eccentric wheel through a rocker. The motor is configured to drive the eccentric wheel to rotate. The eccentric wheel includes a enter hole, a plurality of eccentric holes, and a connecting rod. The center hole is fixedly connected to the eccentric wheel. The eccentric holes are disposed on the eccentric wheel. The connecting rod is fixedly mounted on one of the eccentric holes. The rocker is sleeved on the connecting rod to realize a rotatable connection. The connecting rod is configured to rotate with the eccentric wheel to drive the rocker to realize a reciprocating motion of the upper rack.

Furthermore, between the eccentric wheel and the motor, the spray device further includes a gearbox. One end of the gearbox is rotatably connected to a center shaft of the eccentric wheel by a first gear, and another end of the gearbox is rotatably connected to the motor by a second gear.

Furthermore, the spray device further includes a lower rack. The plurality of nozzles are evenly arranged on an upper surface of the lower rack. The lower rack is fixedly connected to the upper rack. In response to the lower rack being synchronized with the upper rack to perform the reciprocating motion, a substrate between the lower rack and the upper rack is sprayed.

Furthermore, the upper rack further includes a plurality of pipes and a main pipe. One ends of the pipes are connected to inlet ports of the nozzles in one-to-one correspondence, and another ends of the plurality of pipes are connected to the main pipe.

Furthermore, the upper rack further includes at least one roller disposed on a surface of the upper rack to enable the upper rack to slide in a direction of the reciprocating motion with respect to the top of the spray chamber.

Furthermore, the roller is located at a lower surface of the upper rack and extends to both sides of the upper rack in the direction of the reciprocating motion.

Furthermore, the roller is located at an upper surface of the upper rack and disposed at a center position of the upper rack in the direction of the reciprocating motion, and the roller is slidably mounted on the top of the spray chamber.

Furthermore, the upper rack further includes a hinge bar. One end of the hinge bar is rotatably disposed on an upper surface of the upper rack, and another end of the hinge bar is rotatably disposed on the top of the spray chamber so that the upper rack is capable of performing the reciprocating motion relative to the top of the spray chamber.

Furthermore, a hinge bar is rotatably disposed at a center line of an upper surface of the upper rack. The center line is in accordance with a direction of the reciprocating motion.

Furthermore, the nozzles are configured to spray a pure water or an etching liquid.

Advantages of the present disclosure are as follows. A spray device is provided, and by driving a spray rack for spraying with a reciprocating motion, the spray rack can swing from 30° to 60°, which can effectively avoid a substrate being subjected to an uneven spray caused by an individual nozzle is clogged. Therefore, the substrate is sprayed evenly, and an offset of the spray is reduced. The substrate is sprayed evenly, and a production efficiency and product quality are improved.

### BRIEF DESCRIPTION OF DRAWINGS

FIG. 1 is a flowchart of spraying and etching an ITO film in the prior art.

FIG. 2 is a top view of a spray device according to a first embodiment of the present disclosure.

FIG. 3 is a front view of the spray device according to the first embodiment of the present disclosure.

FIG. 4 is a right side view of the spray device according to the first embodiment of the present disclosure.

FIG. 5 is a schematic diagram of an eccentric wheel according to the first embodiment of the present disclosure.

FIG. 6 is a schematic diagram showing a swing principle of the eccentric wheel according to the first embodiment of the present disclosure.

FIG. 7 is a right side view of the spray device according to a second embodiment of the present disclosure.

Reference numerals of components in the drawings are as follow. upper rack 1; connector 2; eccentric wheel 3; motor 4; rocker 5; gearbox 6 lower rack 7; spray device 10; nozzle 11; pipe 12; roller 13 hinge bar 14; main pipe 15; spray chamber 20; substrate 30; center shaft 31 center hole 32; eccentric hole 33; connecting rod 34; first gear 61; second gear 62

### DETAILED DESCRIPTION

In the specification of the present disclosure, it is to be understood that terms such as “central”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, and “counterclockwise” should be construed to refer to the orientation as then described or as shown in the drawings under discussion. These relative terms are for convenience of description and do not require that the present disclosure be constructed or operated in a particular orientation. In addition, terms such as “first” and “second” are used herein for purposes of description and are not intended to indicate or imply relative importance or significance or to imply the number of indicated technical features. Thus, the feature defined with “first” and “second” may include one or more of this feature. In the description of the present disclosure, “a plurality of” means two or more than two, unless specified otherwise.

In the present disclosure, unless specified or limited otherwise, the terms “mounted,” “connected,” “coupled”, and “fixed” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the detail embodiment of the present disclosure.

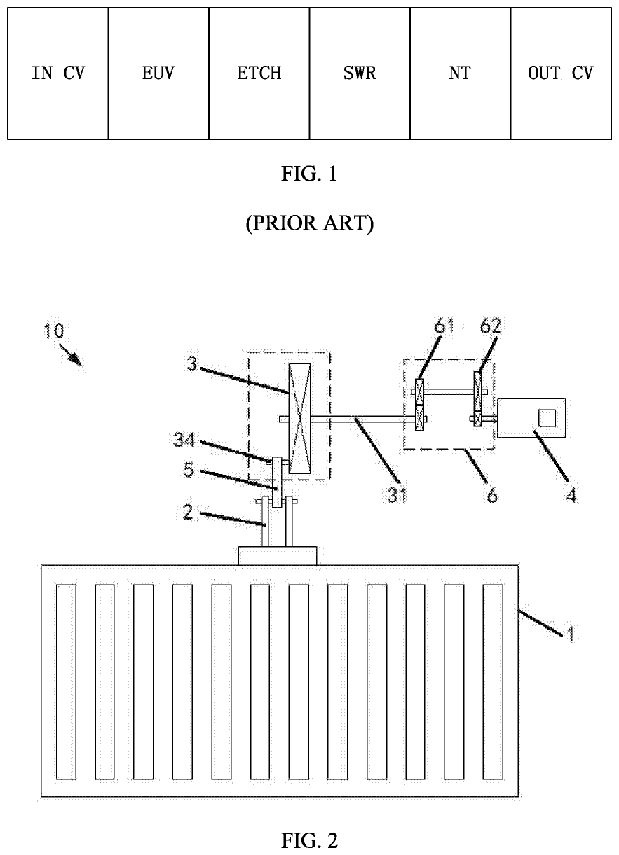

Referring to FIG. 1, a surface of a substrate is covered with an ITO film, and the substrate enters an input unit (IN CV). Organic matter on the surface is removed in a cleaning chamber (EUV), and then substrate enters an etching chamber (ETCH). In the etching chamber, a portion the ITO film which is not required to remain (i.e., a portion of the ITO film which is not covered by a photoresist pattern) on the substrate is removed by an etchant. The substrate then leaves and is cleaned by a water washing unit (SWR) to remove the etchant remaining on the surface of the substrate. Finally, the substrate is dried and transferred out of a spray device by a transfer unit (NT) and an outlet unit (OUT CV).

Referring to FIG. 2 to FIG. 4, the present disclosure provides a spray device 10 which is capable of using in a production process of a liquid crystal display and disposed in a spray chamber 20 (e.g., an etching chamber or a water washing unit). The spray device 10 includes an upper rack 1, a connector 2, an eccentric wheel 3, and a motor 4. Specifically, the upper rack 1 is movably mounted on a top of the spray chamber 20. A plurality of nozzles 11 are evenly arranged under the upper rack 1. The connector 2 is disposed on one side of the upper rack 1, and is rotatably connected to the eccentric wheel 3 through a rocker 5. The motor 4 is configured to drive a center shaft 31of the eccentric wheel 3 to rotate.

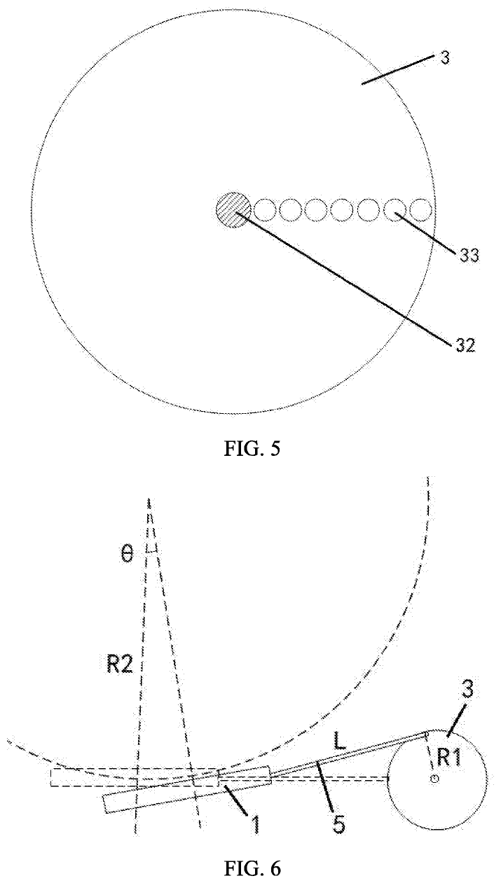

Referring to FIG. 5, the eccentric wheel 3 is provided with a center hole 32, a plurality of eccentric holes 33, and a connecting rod 34. The center hole 32 is disposed at a center of the eccentric wheel 3, and the center shaft 31 extends through the center hole 32 and is fixedly connected to the eccentric wheel 3. Distances between each of the eccentric holes 33 and the center hole 32 are different. The connecting rod 34 is fixedly mounted on one of the eccentric hole 33, and the rocker 5 is sleeved on the connecting rod 34 to performer a rotatable connection. The connecting rod 34 is configured to rotate with the eccentric wheel 3 to drive the rocker 5 to realize a reciprocating motion of the upper rack 1. When the connecting rod 34 selects a different eccentric hole 33 that is different in distance from the center hole, the upper rack 1 performs the reciprocating motion of different amplitudes.

Specifically, in operation, the motor 4 is configured to drive the eccentric wheel 3 to rotate. By the connecting rod 34 and the connector 2, the upper rack 1 is driven to perform the reciprocating motion. If the connecting rod 34 is assembled with an eccentric hole 33 having a different distance from the center hole, the upper rack 1 is swung with different amplitudes. That is, the upper rack 1 performs the reciprocating motion. A swing angle of a center line of the upper rack 1 ranges from 30° to 60°, preferably 30°, 45°, or 60°. As shown in FIG. 6, relevant factors affecting the magnitude of the swing angle 0 of the center line (dashed line in FIG. 6) of the upper rack 1 include: a distance R1 of the eccentric hole 33 and the center hole 32, a length L of the rocker 5, and a radius R2 of a circle of a swinging arc of the upper rack 1. A swing distance of the upper rack 1 in the reciprocating motion is (L+R1)−\sqrt{L²+R1²}. The swing distance of the upper rack 1 in the reciprocating motion is equal to an arc length corresponding to the swing angle θ. According to a formula of the arc length, (L+R1)−\sqrt{L²+R1²}=θ×R2, a value of the angle θ can be obtained.

In the first embodiment, the eccentric holes 33 are preferably arranged in a straight line to facilitate installation and aesthetics. Setting the plurality of eccentric holes 33 in this way can easily adjust a deflection angle of the upper rack 1 when performing the reciprocating motion, i.e., amplitude of the reciprocating motion of the upper rack 1. Thus, the substrate 30 located below the upper rack 1 can be uniformly sprayed, so that a water receiving area per unit time is increased, and the spraying speed and uniformity are greatly improved.

As shown in FIG. 2, in the first embodiment, a gearbox 6 is further provided between the eccentric wheel 3 and the motor 4. One end of the gearbox 6 is rotatably connected to the center shaft 31 of the eccentric wheel 3 via a first gear 61, and the other end of the gearbox 6 is rotatably connected to the motor 4 via a second gear 62. A speed can be changed by adjusting outer diameters of the first gear 61 and the second gear 62, which can achieve both acceleration and deceleration.

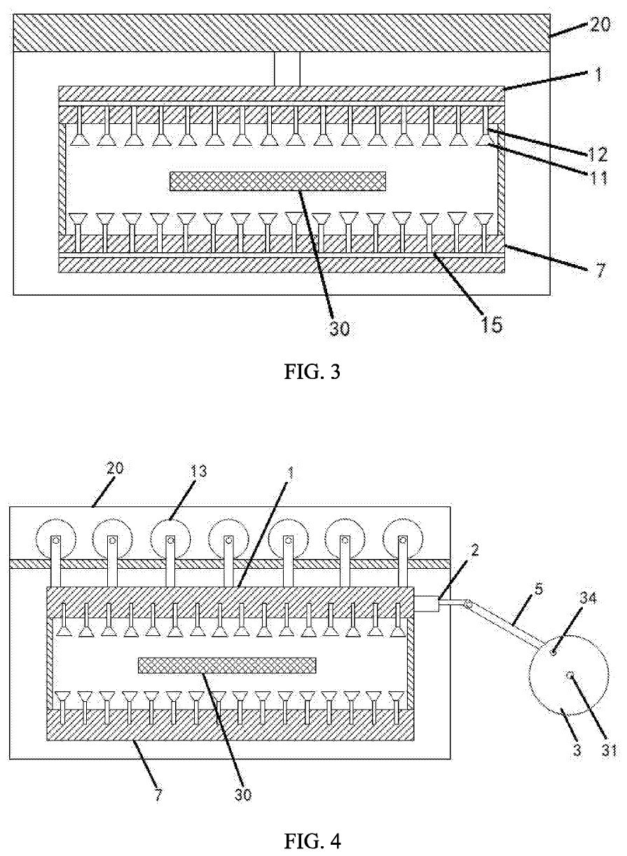

Referring to FIG. 3 to FIG. 6, in the first embodiment, the spray device 10 further includes a lower rack 7. An upper surface of the lower rack 7 is evenly arranged with the plurality of nozzles 11. The lower rack 7 is fixedly connected to the upper rack 1. The lower rack 7 performs the reciprocating motion in synchronization with the upper rack 1, so the substrate between the lower rack 7 and the upper rack 1 is sprayed.

Referring to FIG. 3 and FIG. 4, in the first embodiment, the upper rack 1 further includes a plurality of pipes 12 and a main pipe 15. The pipes 12 are connected to liquid inlets of the nozzles 11 in one-to-one correspondence. The other ends of the plurality of pipes 12 are connected to the main pipe 15 of the upper rack 1 to simplify the structure. The spraying of all of the pipes 12 can be achieved just by supplying the main pipe 15 with a certain pressure of the spray liquid.

Referring to FIG. 4, in the first embodiment, the upper rack 1 further includes at least one roller 13 disposed on a surface of the upper rack 1 to enable the upper rack 1 to slide in a direction of the reciprocating motion with respect to the top of the spray chamber 20.

In the first embodiment, the roller 13 is located on a lower surface of the upper rack 1 extends to both sides of the upper rack 1 in the direction of the reciprocating motion. In other embodiments, the roller 13 is located at an upper surface of the upper rack 1 and disposed at a center position of the upper rack 1 in the direction of the reciprocating motion. The roller 13 is slidably mounted on the top of the spray chamber 20.

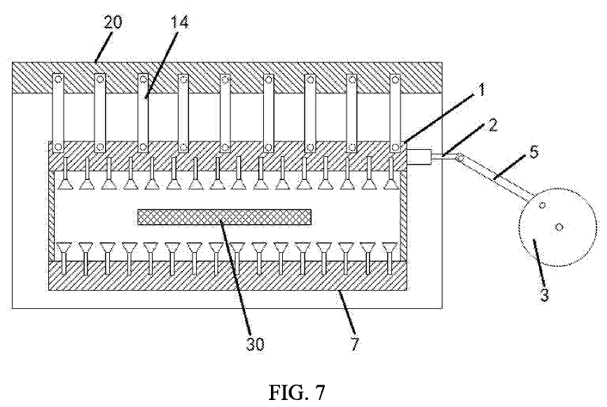

Referring to FIG. 7, in the second embodiment, the upper rack 1 also includes a hinge bar 14. One end of the hinge bar 14 is rotatably disposed on an upper surface of the upper rack 1. The hinge bar 14 is preferably located at a center line of the upper surface of the upper rack 1. The center line is parallel with the direction of the reciprocating motion. The other end of the hinge bar 14 is rotatably disposed on the top of the spray chamber 20, so that the reciprocating motion of the upper rack 1 relative to the top of the spray chamber 20 can be achieved.

In the second embodiment, the hinge bar 14 is rotatably disposed at the center line of the upper surface of the upper rack 1, and the center line is substantially parallel to the direction of the reciprocating motion, that is, the center line is in accordance with the direction of the reciprocating motion.

In the first embodiment and the second embodiment, the nozzles 11 spray pure water (i.e., deionized water) or etching liquid. If the nozzles 11 spray the pure water, the spray device 10 of the present disclosure serves as a cleaning device, in which case the spray chamber 20 is a water washing unit. If the nozzles 11 spray the etching liquid, the spray device 10 of the present disclosure serves as an etching device, in which case the spray chamber 20 is an etching chamber.

Advantages of the present disclosure are as follows. A spray device is provided, and by driving a spray rack for spraying with a reciprocating motion, the spray rack can swing from 30° to 60°, which can effectively avoid a substrate being subjected to an uneven spray caused by an individual nozzle is clogged. Therefore, the substrate is sprayed evenly, and an offset of the spray is reduced. The substrate is sprayed evenly, and a production efficiency and product quality are improved.

The foregoing is only preferred embodiments of the present disclosure. It should be noted that modifications and adaptations may be made by those skilled in the art without departing from the principles of the present disclosure, and should be considered to be within the scope of protection of the present disclosure.

What is claimed is:

1. A spray device capable of using in a production process of a liquid crystal display and disposed in a spray chamber, comprising an upper rack, a connector, an eccentric wheel, and a motor;
wherein the upper rack is movably mounted on a top of the spray chamber, and a plurality of nozzles are evenly arranged below the upper rack;
the connector is disposed on one side of the upper rack, and is rotatably connected to the eccentric wheel through a rocker;
the motor is configured to drive the eccentric wheel to rotate;
wherein the eccentric wheel comprises:
a center hole disposed at a center of the eccentric wheel, wherein a center shaft is fixedly connected to the eccentric wheel through the center hole;
a plurality of eccentric holes disposed on the eccentric wheel; and
a connecting rod fixedly mounted on one of the eccentric holes, wherein the rocker is sleeved on the connecting rod to realize a rotatable connection, and the connecting rod is configured to rotate with the eccentric wheel to drive the rocker to realize a reciprocating motion of the upper rack.

2. The spray device as claimed in claim 1, wherein between the eccentric wheel and the motor, the spray device further comprises a gearbox, wherein one end of the gearbox is rotatably connected to the center shaft of the eccentric wheel by a first gear, and another end of the gearbox is rotatably connected to the motor by a second gear.

3. The spray device as claimed in claim 1, further comprising a lower rack, wherein the plurality of nozzles are evenly arranged on an upper surface of the lower rack, and the lower rack is fixedly connected to the upper rack, and in response to the lower rack being synchronized with the upper rack to perform the reciprocating motion, a substrate between the lower rack and the upper rack is sprayed.

4. The spray device as claimed in claim 1, wherein the upper rack further comprises:
a plurality of pipes, wherein one ends of the pipes are connected to inlet ports of the nozzles in one-to-one correspondence; and
a main pipe, wherein another ends of the plurality of pipes are connected to the main pipe.

5. The spray device as claimed in claim 1, wherein the upper rack further comprises at least one roller disposed on a surface of the upper rack to enable the upper rack to slide in a direction of the reciprocating motion with respect to the top of the spray chamber.

6. The spray device as claimed in claim 5, wherein the roller is located at a lower surface of the upper rack and extends to both sides of the upper rack in the direction of the reciprocating motion.

7. The spray device as claimed in claim 5, wherein the roller is located at an upper surface of the upper rack and disposed at a center position of the upper rack in the direction of the reciprocating motion, and the roller is slidably mounted on the top of the spray chamber.

8. The spray device as claimed in claim 1, wherein the upper rack further comprises a hinge bar, one end of the hinge bar is rotatably disposed on an upper surface of the upper rack, and another end of the hinge bar is rotatably disposed on the top of the spray chamber so that the upper rack is capable of performing the reciprocating motion relative to the top of the spray chamber.

9. The spray device as claimed in claim 1, wherein the upper rack further comprises a hinge bar rotatably disposed at a center line of an upper surface of the upper rack, wherein the center line is parallel to a direction of the reciprocating motion.

10. The spray device as claimed in claim 1, wherein the nozzles are configured to spray a pure water or an etching liquid.
